(19) United States
(12) Patent Application Publication
(10) Pub. No.: US 2007/0230180 A1
(43) Pub. Date: Oct. 4, 2007

(54) Projector

(75) Inventor: Katsuyuki Uehara, Azumino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/727,437

(22) Filed: Mar. 27, 2007

(30) Foreign Application Priority Data
Mar. 28, 2006 (JP) 2006-089070

(51) Int. Cl. F21V 19/02

(52) U.S. Cl. 362/285

(57) ABSTRACT

A projector according to an aspect of the invention includes: a light source device, the light source device including a light source lamp and a reflector, the light source lamp having a pair of electrodes and a light-emitting tube in which the pair of electrodes are arranged, the reflector fixed to the exterior casing and irradiating the light beam radiated from the light source lamp in a certain direction; an optical modulator that modulates a light beam irradiated from the light source device; a projection optical device that projects the light beam modulated by the optical modulator in an enlarged manner; an exterior casing that houses the light source device, the optical modulator, and the projection optical device to be arranged therein; and a light source lamp support portion that supports the light source lamp, the light source lamp support portion being adapted to change a position of the light source lamp with respect to the reflector in accordance with a posture of the projector, the posture including a normally placed posture in which the projector is placed at a predetermined position and a ceiling-hung posture in which the projector is arranged inversely from the normally placed posture in a vertical direction.

The entire disclosure of Japanese patent application no. 2006-089070, filed Mar. 28, 2006, is expressly incorporated by reference herein.

### BACKGROUND

1. Technical Field

The present invention relates to a projector.

2. Related Art

As a related art, a projector is known which includes a light source device, a optical modulator that modulates a light beam irradiated from the light source device, a projection optical device that projects the modulated light beam in an enlarged manner, and an exterior casing in which these components are housed and arranged.

In the projector, as the light source device, for instance, a discharge-type light source device is frequently used, which includes a light source lamp that emits light by an electric discharge between one pair of electrodes and a reflector that aligns light beams emitted from the light source lamp in a certain direction and irradiates the aligned light beams. In such light source device, a temperature in the light source lamp rises due to heat generation resulting from the light emission and there occurs heat convection, which leads to a vertical temperature difference in the light source lamp and unevenness of concentration distribution of a gas. Therefore, an arc that occurs between the pair of electrodes is bent in an upward vertical direction, which leads to a situation in which a center position of the arc is displaced in the upward vertical direction with respect to a center position between the pair of electrodes.

When the light source device is assembled, the light source lamp is attached to the reflector so that the center position of the arc is located at a predetermined position of the reflector (for instance, in a case of a parabolic reflector, the predetermined position is a focal position of the parabolic reflector, and in a case of an ellipsoidal reflector, the predetermined position is a first focal position of the ellipsoidal reflector).

However, when the projector is arranged to support both of a normally placed posture (state in which the projector is placed on an installation surface of a desk or the like) and a ceiling-hung posture (state in which the projector is hung from a ceiling or the like so that a top and a bottom are inverted from those in the normally placed posture), the top and the bottom of the light source device are inverted between the normally placed posture and the ceiling-hung posture, and thus the bent direction of the arc is inverted.

Therefore, in a case where the light source device is assembled by attaching the light source lamp to the reflector in the manner described above in the normally placed posture, when the projector is used in the ceiling-hung posture, the center position of the arc is displaced from the predetermined position of the reflector due to the inverted bending of the arc.

When the center position of the arc is displaced from the predetermined position of the reflector in the manner described above, an optical axis of the light beam irradiated from the light source lamp is displaced from a design optical axis that traces an optical system disposed on an optical path downstream side of the light source device. Therefore, it becomes impossible to effectively apply the light beam irradiated from the light source device to the optical modulator, which lowers use efficiency of light. In this case, there might occur a problem concerning a projection image projected by the projector, such as degradation of illuminance, deterioration of an illuminance ratio, or occurrence of color unevenness.

As a countermeasure against the problem, there has been disclosed a projector capable of maintaining the use efficiency of light while supporting both of the normally placed posture and the ceiling-hung posture of the projector (see, for instance, Document: JP-A-8-314010).

In the projector described in the Document, a lamp unit including a metal halide lamp and a parabolic reflector is formed in a cylindrical shape with its center axis being set at an optical axis. Also, an internal shape of a lamp unit mounting portion to which the lamp unit is mounted is formed in a cylindrical shape corresponding to the external profile of the lamp unit. Further, the lamp unit is arranged so as to be rotatable by 180° about the optical axis as the center axis in the lamp unit mounting portion. With this arrangement, it becomes possible to rotate the lamp unit in accordance with the posture (the normally placed posture and the ceiling-hung posture) of the projector, thereby setting the center position of the arc at the predetermined position of the reflector.

However, since the projector described in the Document, employs a structure in which the lamp unit is rotated in accordance with the posture of the projector, an operation (lamp unit rotating operation) according to the posture of the projector is bothersome.

Also, in order to smoothly rotate the lamp unit with respect to the lamp unit mounting portion, a rotary mechanism is required, which increases the size of the light source device.

Therefore, there is a demand for a technique that can maintain the use efficiency of light while supporting both of the normally placed posture and the ceiling-hung posture through a simple operation without increasing the size of the light source device.

### SUMMARY

An advantage of some aspects of the present invention is to provide a projector capable of maintaining use efficiency of light while supporting both of a normally placed posture and a ceiling-hung posture with a simple arrangement that does not increase the size of a light source device.

A projector according to an aspect of the invention includes: a light source device, the light source device including a light source lamp and a reflector, the light source lamp having a pair of electrodes and a light-emitting tube in which the pair of electrodes are arranged, the reflector fixed to the exterior casing and irradiating the light beam radiated from the light source lamp in a certain direction; an optical modulator that modulates a light beam irradiated from the light source device; a projection optical device that projects the light beam modulated by the optical modulator in an enlarged manner; an exterior casing that houses the light source device, the optical modulator, and the projection optical device to be arranged therein; and a light source lamp support portion that supports the light source lamp, the light source lamp support portion being adapted to change a position of the light source lamp with respect to the reflector in accordance with a posture of the projector, the posture including a normally placed posture in which the projector is placed at a predetermined position and a ceiling-hung posture in which the projector is arranged inversely from the normally placed posture in a vertical direction.

In this case, examples of the reflector may include a parabolic reflector and an ellipsoidal reflector.

In a related art, at the time of assembling a light source device, first, a light source lamp is installed so that a center position of an arc of the light source lamp is arranged at a focal position of a reflector in a state where a projector is installed in a normally placed posture. However, when the projector is installed in a ceiling-hung posture, a bent direction of the arc of the light source lamp is inverted, so that the center position of the arc is displaced from the focal position of the reflector.

In the aspect of the invention, however, the light source lamp support portion is arranged to be capable of changing a position of the light source lamp with respect to the reflector in accordance with the posture (the normally placed posture or the ceiling-hung posture) of the projector. Therefore, it becomes possible to arrange a center position of an arc at a focal position of the reflector by moving the position of the light source lamp with the light source lamp support portion.

As a result, it becomes possible to correct an optical axis of the light beam irradiated from the light source device so as to coincide with a design optical axis of an optical system disposed on an optical path downstream side of the light source device, which makes it possible to effectively apply the light beam irradiated from the light source device to the optical modulator. Accordingly, it becomes possible to maintain the use efficiency of light at the optical modulator regardless of the posture of the projector.

Also, since the projector according to the aspect of the invention has a structure in which the light source lamp is moved, it can be said that the projector can be arranged in a smaller size as compared with a structure in which a whole lamp unit is rotated like in the related art. Accordingly, it becomes possible to maintain the use efficiency of light of the optical modulator with a simple structure that does not increase the size of the projector.

According to the aspect of the invention, it is preferable that the light source lamp support portion is adapted to change the position of the light source lamp with respect to the reflector in the vertical direction.

In this case, the arc is always bent in an upward vertical direction due to heat convection in the light-emitting tube, and therefore when the posture of the projector is changed from the normally placed posture to the ceiling-hung posture or from the ceiling-hung posture to the normally placed posture, a displacement that is generated between the center position of the arc and the focal position of the reflector is formed in the vertical direction at all times.

According to the aspect of the invention, since the light source lamp support portion is capable of changing the position of the light source lamp in the vertical direction, it can satisfactorily cope with the displacement between the center position of the arc and the focal position of the reflector caused by the changing of the posture of the projector. In addition, since the light source lamp support portion is required to be capable of moving the position of the light source lamp only in the vertical direction, an increase in size of the projector can further be suppressed and the use efficiency of light of the optical modulator can be maintained with a simpler structure.

According to the aspect of the invention, it is preferable that an arc is formed between the pair of electrodes of the light source lamp due to discharge light emission when a voltage is applied. The light source lamp support portion changes the position of the light source lamp such that a center position of the arc with respect to the reflector in the normally placed posture of the projector and a center position of the arc with respect to the reflector in the ceiling-hung posture of the projector coincide with each other.

In this case, a bent shape of the arc remains substantially the same regardless of the posture of the projector, and thus a distance from a mechanical center line of the arc (a line connecting center points of the pair of electrodes to each other) to the center position of the arc also remains substantially constant regardless of the posture of the projector. Accordingly, the center position of the arc after the changing of the posture of the projector can be grasped to some extent.

According to the aspect of the invention, the light source lamp support portion changes the position of the light source lamp so that the center position of the arc with respect to the reflector at the time of the normally placed posture of the projector and the center position of the arc with respect to the reflector at the time of the ceiling-hung posture coincide with each other. As described above, since the center position of the arc after the changing of the posture of the projector can be grasped to some extent, by setting in advance an amount of a movement of the light source lamp by the light source lamp support portion to according to the changing of the posture of the projector, it becomes possible to swiftly eliminate the displacement that is generated between the center position of the arc and the focal position at the time of the changing of the posture of the projector.

Therefore, at the time of the changing of the posture of the projector, it is unnecessary for a user of the projector to adjust the position of the light source lamp with the light source lamp support portion while monitoring a positional relation between the center position of the arc and the focal position of the reflector. Accordingly, it becomes possible to maintain the use efficiency of light of the optical modulator without necessity of bothersome operations of the user.

According to the aspect of the invention, it is preferable that the reflector has a substantially bowl-like shape in which the light-emitting tube is arranged, the reflector including: an opening that exposes one end portion of the light-emitting tube, the opening formed on an irradiation side of the light beam irradiated by the reflector in the certain direction; and an insertion hole through which the other end portion of the light-emitting tube is inserted, the insertion hole formed on a side opposite to the light-irradiation side. The light source lamp support portion supports at least one of the end portion of the light-emitting tube exposed from the opening and the other end portion of the light-emitting tube inserted through the insertion hole and extending to an outside of the reflector.

According to the aspect of the invention, the light source lamp support portion supports the light-emitting tube of the light source lamp at least one of an outside position on a light-irradiation side of the reflector and an outside position on a side opposite to the light-irradiation side. Accordingly, the light source lamp support portion can support the light source lamp without interfering with radiation and reflection of light in the reflector.

In addition, when the light source lamp support portion is set to support the light-emitting tube at the outside position on the side opposite to the light-irradiation side of the reflector, for instance, the light beam irradiated from the reflector is not blocked. Accordingly, in this case, the light source lamp support portion can support the light source lamp without lowering the use efficiency of light at the optical modulator. Also, when the light source lamp support portion is set to support the light-emitting tube at both of the outside position on the light-irradiation side of the reflector and the outside position on the side opposite to the light-irradiation side, for instance, the light source lamp can be stably supported.

According to the aspect of the invention, it is preferable that the light source lamp support portion includes an irradiation-side light-transmissive support portion. The irradiation-side light-transmissive support portion has a light-transmissive property, supports the end portion of the light-emitting tube exposed from the opening of the reflector, and is adapted to change the position of the light source lamp with respect to the reflector.

According to the aspect of the invention, since the irradiation-side light-transmissive support portion has a light-transmissive property, the light beam irradiated from the reflector is not blocked. Accordingly, the light source lamp support portion can support the light source lamp without lowering the use efficiency of light at the optical modulator.

In addition, when the light source device is provided with an explosion-proof glass that, when the light source lamp bursts, prevents broken pieces of the light source lamp from scattering to the outside from the light source device, the explosion-proof glass member can be used as the light source lamp support portion. In this case, it becomes possible to prevent an increase of the number of components due to addition of new components.

According to the aspect of the invention, it is preferable that the projector further includes an integrator illumination optical device that is disposed on an optical path downstream side of the light beam irradiated from the light source device, the integrator illumination optical device substantially uniformly illuminating an image forming area of the optical modulator with the light beam. The integrator illumination optical device includes: a first lens array that includes a plurality of first small lenses arranged in a plane substantially orthogonal to an optical axis of an incident light beam, the first lens array dividing the incident light beam into a plurality of sub light beams with the plurality of first small lenses; a second lens array that includes a plurality of second small lenses according to the plurality of first small lenses of the first lens array; and a superposing lens that superposes the incident light beam on the image forming area of the optical modulator together with the second lens array. The light source lamp support portion includes an irradiation-side support portion. The irradiation-side support portion includes a support arm portion that supports the end portion of the light-emitting tube exposed from the opening of the reflector, the irradiation-side support portion adapted to change the position of the light source lamp with respect to the reflector. The support arm portion is arranged in optical paths of, out of the light beam irradiated from the light source device, light in the vicinity of an optical axis of the light beam and light incident on each boundary portion between the plurality of first small lenses of the first lens array.

In this case, in the vicinity of the optical axis of the light beam irradiated from the light source device, the light-emitting tube casts a shadow and therefore a quantity of light is small. In addition, a light incident on each boundary portion between the first small lenses of the first lens array out of the light beam irradiated from the light source device is not appropriately divided by the first small lenses into sub light beams, so that the light is hard to reach the image forming area of the optical modulator. Accordingly, in many cases, out of the light beam irradiated from the light source device, light in the vicinity of the optical axis and the light incident on the boundary portion between the first small lenses of the first lens array are not used in a projection image projected from the projection optical device.

In contrast, according to the aspect of the invention, the support arm portion of the irradiation-side support portion is provided so as to be positioned within optical paths of, out of the light beam irradiated from the light source device, the light in the vicinity of the optical axis and the light incident on the boundary portion between the first small lenses of the first lens array. Accordingly, although the support arm portion blocks the light in the vicinity of the optical axis and the light incident on the boundary portion between the first small lenses of the first lens array, these lights are hard to reach the image forming area of the optical modulator as described above, so that an influence on the projection image is small. Accordingly, the support arm portion is provided so as not to block light that is easy to reach the image forming area of the optical modulator, so that to the support arm portion can support the light source lamp in a state in which the use efficiency at the optical modulator is maintained.

### BRIEF DESCRIPTION OF THE DRAWINGS

The invention will be described with reference to the accompanying drawings, wherein like numbers reference like elements.

FIG. 1 is a schematic plan view showing an arrangement of a projector according to a first exemplary embodiment of the invention;

FIG. 2 is a cross-sectional view showing outlined arrangements of a light source device body and a light source lamp support portion according to the first exemplary embodiment;

FIG. 3 is a schematic diagram showing an arc formed in a light-emission portion according to the first exemplary embodiment;

FIG. 4 is an explanatory diagram of an effect at the time of a normally placed posture of the projector according to the first exemplary embodiment;

FIG. 5 is an explanatory diagram of an effect at the time of a ceiling-hung posture of the projector according to the first exemplary embodiment;

FIG. 6 is another explanatory diagram of an effect at the time of the ceiling-hung posture of the projector according to the first exemplary embodiment;

FIG. 7 is a cross-sectional view showing outlined arrangements of a light source device body and a lamp support portion of a projector according to a second exemplary embodiment of the invention;

FIG. 8 is a cross-sectional view showing outlined arrangements of a light source device body and a lamp support portion of a projector according to a third exemplary embodiment of the invention; and

FIG. 9 shows light quantity distribution of light that reaches liquid crystal panels out of a light beam irradiated from a light source device according to the third exemplary embodiment.

### DESCRIPTION OF EXEMPLARY EMBODIMENTS

Exemplary embodiments of the invention will be described with reference to the accompanying drawings.

### First Exemplary Embodiment

### Outlined Arrangement of Projector 1

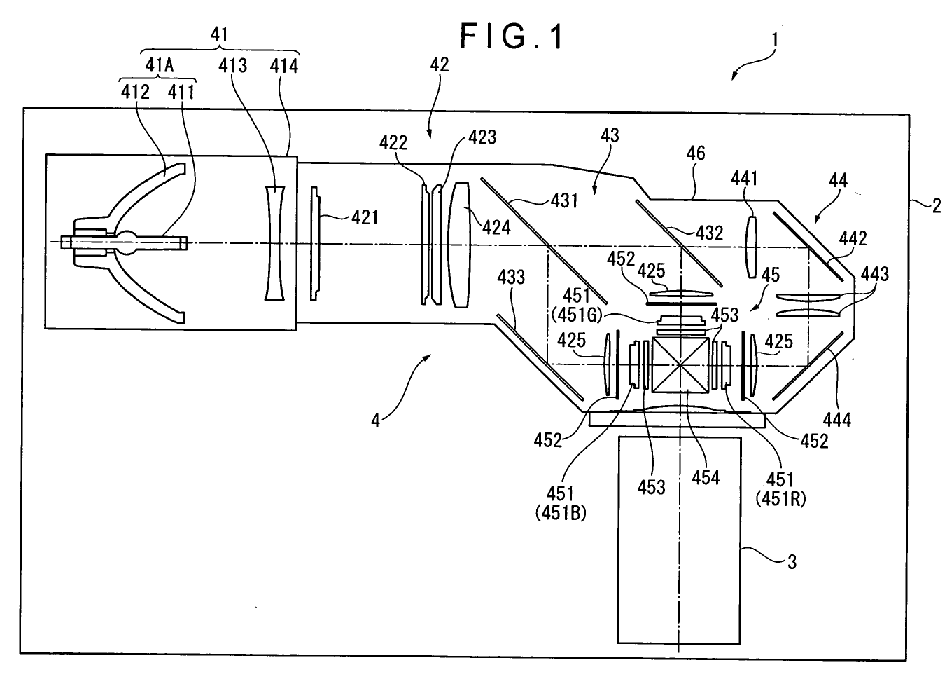

FIG. 1 schematically shows an outlined arrangement of a projector 1 in a first exemplary embodiment of the invention.

The projector 1 in the first exemplary embodiment forms a color image (optical image) by modulating a light beam irradiated from a light source device 41 in accordance with image information and projects this color image on a screen (not shown) in an enlarged manner.

Note that in the first exemplary embodiment, the projector 1 is installable in a state (normally placed posture) in which the projector 1 is placed on an installation surface of a desk or the like and a state (ceiling-hung posture) in which the projector 1 is placed inversely in a vertical direction from the normally placed posture and the projector 1 is suspended from an installation surface of a ceiling or the like.

The projector 1, as shown in FIG. 1, includes an exterior casing 2, a projection lens 3 functioning as a projection optical device, an optical unit 4, and the like. Although not shown in FIG. 1, in the exterior casing 2, a cooling unit that cools the inside of the projector 1, a power supply unit that supplies electric power to each component in the projector 1, a control device that controls each component in the projector 1, and the like are arranged in a space not occupied by the projection lens 3 and the optical unit 4.

The projection lens 3 projects a color image formed at the optical unit 4 onto a screen (not shown) in an enlarged manner. The projection lens 3 is arranged as a lens set in which multiple lenses are housed in a tubular lens-barrel.

### Detailed Arrangement of Optical Unit 4

The optical unit 4 is a unit that forms a color image corresponding to image information by optically processing a light beam irradiated from a light source under the control of the control device. As shown in FIG. 1, the optical unit 4 has a substantially L-shape in plan view and extends along a rear side of the exterior casing 2 and along a lateral side of the exterior casing 2.

The optical unit 4, as shown in FIG. 1, includes the light source device 41, an integrator illumination optical device 42, a color separating optical device 43, a relay optical device 44, an electrooptical device 45, and an optical component casing 46 in which these optical components 42 to 45 are housed and arranged.

The light source device 41 is lit up and irradiates parallel light toward the integrator illumination optical device 42 under the control of the control device. As shown in FIG. 1, the light source device 41 includes a light source device body 41A including a light source lamp 411 and a reflector 412, a parallelizing lens 413, and a lamp housing 414 in which these members 411 to 413 are housed. Also, a radial light beam irradiated from the light source lamp 411 is reflected by the reflector 412 and is converted into parallel light by the parallelizing lens 413.

Although not shown in FIG. 1 the lamp housing 414 is attached to a bottom surface portion of the exterior casing 2 and is connected with the optical component casing 46. The reflector 412 is fixed to an inner wall of the lamp housing 414.

Also, a light source lamp support portion is provided in the lamp housing 414, the light source lamp support portion supporting the light source lamp 411 and allowing a position of the light source lamp 411 to be changed with respect to the reflector 412 in the vertical direction. Arrangements of the light source lamp support portion and the light source device body 41A will be described later in detail.

The integrator illumination optical device 42 is an optical system for approximately uniformly irradiating the light beam irradiated from the light source device 41 on image forming areas of liquid crystal panels (described later) of the electrooptical device 45. As shown in FIG. 1, the integrator illumination optical device 42 includes a first lens array 421, a second lens array 422, a polarization converter 423, and a superposing lens 424.

The first lens array 421 has an arrangement in which first small lenses each having a substantially rectangular profile when viewed from an incident optical axis direction are arranged in a matrix form in a plane substantially orthogonal to an incident optical axis. Each first small lens divides the light beam irradiated from the light source device 41 into a plurality of sub light beams.

The second lens array 422 has substantially the same arrangement as the first lens array 421 and has an arrangement in which second small lenses are arranged in a matrix form. The second lens array 422 has a function of forming an image of each first small lens of the first lens array 421 on the later-described liquid crystal panels of the electrooptical device 45 together with the superposing lens 424.

The polarization converter 423 is arranged between the second lens array 422 and the superposing lens 424 and converts light from the second lens array 422 into approximately one kind of polarization light.

Each sub light converted into the approximately one kind of polarization light by the polarization converter 423 is, ultimately, substantially superposed on the later-described liquid crystal panels of the electrooptical device 45 by the superposing lens 424. In a projector employing liquid crystal panels of a type that modulate polarization light, only one kind of polarization light can be used, so that approximately one half of the light from the light source device 41 irradiating random polarization light cannot be used. Therefore, by using the polarization converter 423, the irradiation light from the light source device 41 is converted into approximately one kind of polarization light, thereby enhancing use efficiency of light at the electrooptical device 45.

The color separating optical device 43, as shown in FIG. 1, includes two dichroic mirrors 431 and 432 and a reflection mirror 433 and has a function of separating the plurality of sub light beams irradiated from the integrator illumination optical device 42 into color lights of red (R), green (G) and blue (B) with the dichroic mirrors 431 and 432.

The relay optical device 44, as shown in FIG. 1, includes an incident-side lens 441, relay lenses 443, and reflection mirrors 442 and 444 and has a function of guiding the red light separated by the color separating optical device 43 to the later-described liquid crystal panel for the red light of the electrooptical device 45.

At this time, the dichroic mirror 431 of the color separating optical device 43 reflects a blue light component of the light beam irradiated from the integrator illumination optical device 42 and transmits a red light component and a green light component. The blue light reflected by the dichroic mirror 431 is reflected by the reflection mirror 433, passes through a field lens 425, and reaches the later-described liquid crystal panel for the blue light of the electrooptical device 45.

This field lens 425 converts each sub light beam irradiated from the second lens array 422 into a light beam that is parallel to a center axis (main beam) thereof. The same applies to field lenses 425 provided on light-incident sides of other liquid crystal panels for the green light and the red light.

The green light, out of the red light and the green light transmitted through the dichroic mirror 431, is reflected by the dichroic mirror 432, passes through the field lens 425, and reaches the later-described liquid crystal panel for the green light of the electrooptical device 45. The red light is transmitted through the dichroic mirror 432, passes through the relay optical device 44, further passes through the field lens 425, and reaches the later-described liquid crystal panel for the red light of the electrooptical device 45.

Note that the reason why the relay optical device 44 is used for the red light is that the length of an optical path of the red light is longer than those of optical paths of the other colors lights and therefore it is required to prevent lowering of the use efficiency of light due to dispersion of light or the like. That is, it is required to transmit a sub light beam that is incident on the incident-side lens 441 to the field lens 425 as it is.

The electrooptical device 45, as shown in FIG. 1, includes three liquid crystal panels 451 functioning as optical modulators (with the liquid crystal panel for the red light being given a reference numeral 451R, the liquid crystal panel for the green light being given a reference numeral 451G, and the liquid crystal panel for the blue light being given a reference numeral “451B”), incident-side polarization plates 452 respectively arranged on light-incident sides of these liquid crystal panels 451, irradiation-side polarization plates 453 respectively arranged on light-irradiation sides of the liquid crystal panels 451, and a cross dichroic prism 454.

The incident-side polarization plates 452 are each a member that, out of the color lights separated by the color separating optical device 43, transmits only polarization light having a polarization axis in the same direction as the polarization axis aligned by the polarization converter 423 and absorbs other light beams. The incident-side polarization plate 452 is obtained by sticking a polarization film onto a light-transmissive substrate made of sapphire glass or the like. Note that the incident-side polarization plates 452 may be arranged by sticking the polarization film to the field lenses 425 without using the light-transmissive substrate.

The liquid crystal panels 451R, 451G, and 451B each have an arrangement in which a liquid crystal that is an electrooptical substance is hermetically filled in between a pair of transparent glass substrates, the liquid crystal panels 451R, 451G, and 451B modulating a polarization direction of the polarization light beam irradiated from the incident-side polarization plate 452 by controlling the orientation state of the liquid crystal in the image forming area in accordance with image information.

The irradiation-side polarization plates 453 are each arranged in approximately the same manner as the incident-side polarization plates 452, irradiation-side polarization plate 453 transmitting only a light beam having a polarization axis orthogonal to the polarization axis of the light beam transmitted through the incident-side polarization plate 452 out of the light beam irradiated from the image forming area of the liquid crystal panel 451 and absorbing other light beams.

The cross dichroic prism 454 is an optical element that forms a color image by combining optical images modulated for each color light irradiated from the irradiation-side polarization plates 453. The cross dichroic prism 454 has a substantially square shape in plan view in which four rectangular prisms are bonded together and two dielectric multilayer films are formed on the boundaries between the rectangular prisms. Those dielectric multilayer films transmit the color light irradiated from the liquid crystal panel 451G and transmitted through the irradiation-side polarization plate 453 and reflects the color light irradiated from the liquid crystal panels 451R and 451B and transmitted through the irradiation-side polarization plates 453. In this manner, the color lights are combined and a color image is formed.

### (Arrangements of Light Source Device Body 41A and Light Source Lamp Support Portion 50)

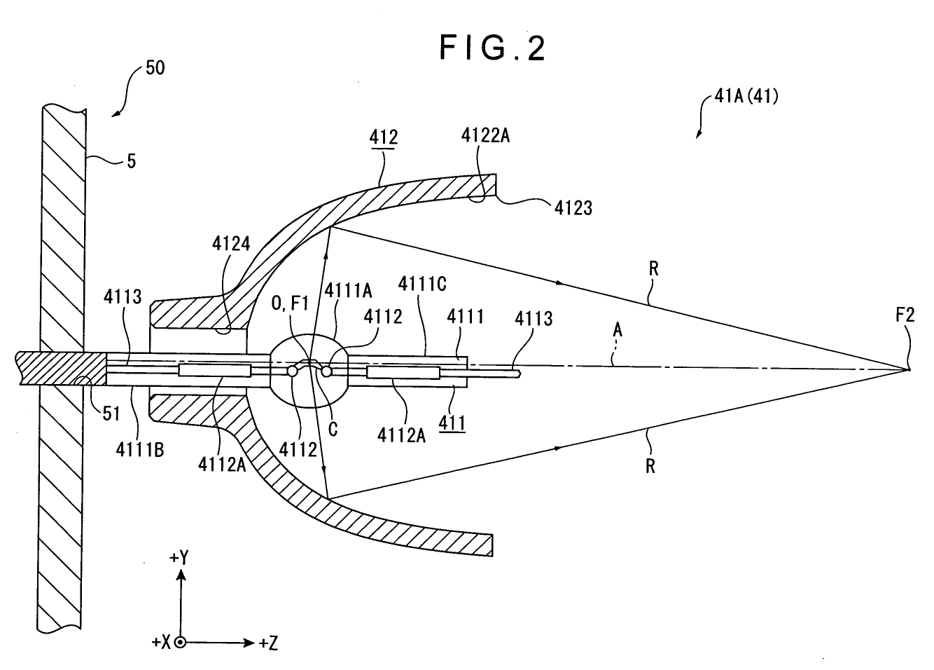

Next, detailed arrangements of the light source device body 41A and the light source lamp support portion 50 will be described with reference to FIGS. 2 to 6.

Note that in FIGS. 2 to 6, for ease of explanation, the optical axis of the light beam irradiated from the light source device 41 is set as a Z axis and two axes orthogonal to the Z axis are respectively set as a X axis (horizontal axis) and the Y axis (vertical axis). Also, the irradiation direction of the light beam from the light source device 41 is set as a +Z-axis direction. Further, an upward vertical direction at the time of the normally placed posture of the projector 1 is set as a +Y-axis direction and a downward vertical direction is set as a −Y-axis direction. In other words, an upward vertical direction at the time of the ceiling-hung posture of the projector 1 is set as a −Y-axis direction and a downward vertical direction is set as a +Y-axis direction.

FIG. 2 is a Y-Z cross-sectional view showing outlined arrangements of the light source device body 41A and the light source lamp support portion 50 of the projector 1 in the normally placed posture.

The light source device body 41A, as shown in FIG. 2, includes the light source lamp 411 and the reflector 412 having a substantially bowl-like shape in which the light source lamp 411 is arranged. Also, in the lamp housing 414 (FIG. 1), the light source lamp support portion 50 is provided in addition to the light source device body 41A.

The light source lamp 411, as shown in FIG. 2, includes a light-emitting tube 4111 formed by a quartz glass tube, one pair of electrodes 4112 that are arranged in the light-emitting tube 4111, and a sealed matter (not shown) such as mercury, a noble gas, or a small amount of halogen. Note that as the light source lamp 411, various light source lamps that perform high-intensity light emission can be employed, examples of which are a metal halide lamp, a high pressure mercury lamp, and an extra-high pressure mercury lamp.

The light-emitting tube 4111 includes a bulge portion 4111A which bulges substantially spherically at a center portion and has one pair of sealing portions 4111B and 4111C that extend from both sides of the bulge portion 4111A.

A discharge space having a substantially spherical shape is formed in the bulge portion 4111A, the pair of electrodes 4112 is arranged in this discharge space, and the sealed matter or the like is sealed in the discharge space.

Metal foils 4112A made of molybdenum are inserted in the pair of sealing portions 4111B and 4111C, the metal foils 4112 electrically connected with the pair of electrodes 4112 arranged in the bulge portion 411 1A. Each end portion of the sealing portions 4111B and 4111C is sealed with a glass material or the like.

Also connected to each metal foil 4112A is a lead wire 4113 functioning as an electrode leader line, the lead wire 4113 extending to the outside of the light source lamp 411. With this arrangement, when a voltage is applied to the lead wire 4113, as shown in FIG. 2, discharge occurs due to a potential difference generated between the electrodes 4112 through the metal foils 4112A, which generates an arc C and causes the inside of the bulge portion 4111A to emit light.

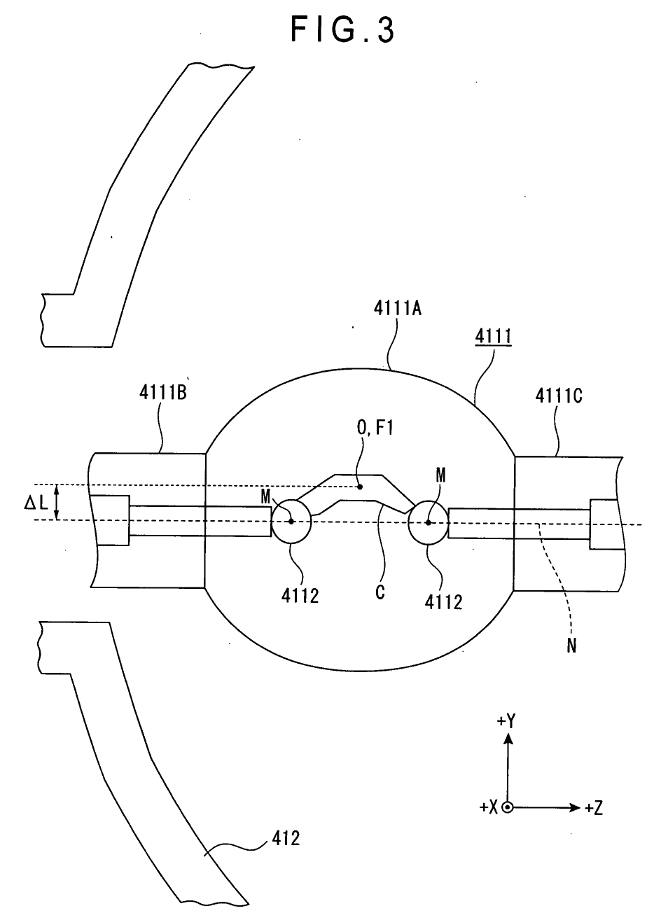

FIG. 3 is a schematic diagram showing the arc C generated between the pair of electrodes 4112.

In the bulge portion 4111A, a temperature rises due to heat generation resulting from the discharge light emission between the pair of electrodes 4112. Under this condition, heat convection occurs in the bulge portion 4111A, and therefore concentration distribution of the sealed matter becomes uneven. Therefore, as shown in FIG. 3, the arc C that occurs between the pair of electrodes 4112 is bent in the upward vertical direction.

Here, in FIG. 3, a mechanical center line extending along the Z-axis direction of the light source lamp 411 is set as a line N connecting center points M in the Y-axis direction of the electrodes 4112 to each other and a distance in the Y-axis direction from this mechanical center line N to the center position O of the arc C is set as “ΔL”. Note that the center position O of the arc C is a position at which a center line in the X-axis direction and a center line in the Y-axis direction in an X-Y plan view of the arc C overlap each other.

Also, such a bent shape of the arc C is similarly caused in both of the normally placed posture and the ceiling-hung posture of the projector 1. That is, regardless of whether the projector 1 is installed in the normally placed posture or the ceiling-hung posture, the shape of the arc C is bent in the upward vertical direction.

Referring again to FIG. 2, the reflector 412 converges the light beam radiated from the light source lamp 411 and irradiates the converged light beam in the +Z-axis direction (direction toward the parallelizing lens 413 and the integrator illumination optical device 42).

The reflector 412 is formed in a substantially bowl-like shape using a glass having a light-transmissive property, in which the light-emitting tube 4111 is arranged. As shown in FIG. 2, the reflector 412 includes: an insertion hole 4124 through which the sealing portion 4111B of the of the light-emitting tube 4111 is inserted, the insertion hole 4124 formed on a side end portion in the −Z-axis direction; and an opening 4123 through which the light beam radiated from the light-emitting tube 4111 is irradiated and the sealing portion 4111 IC is exposed, the opening 4123 formed on an end portion in the +Z-axis direction.

An interior surface of the reflector 412 has an elliptically curved surface shape, o which a reflection surface 4122A is formed by forming a metallic thin film through vapor deposition. The reflection surface 4122A is a cold mirror that reflects visible rays and transmits infrared rays and ultraviolet rays.

The insertion hole 4124 is formed in a track shape having a long diameter in the Y-axis direction. Through this insertion hole 4124, the sealing portion 4111B of the light-emitting tube 4111 is inserted. Note that in the first exemplary embodiment, as shown in FIG. 2, the sealing portion 4111B that is inserted through the insertion hole 4124 and extends to the outside of the reflector 412 is supported by the light source lamp support portion 50.

### Arrangement of Light Source Lamp Support Portion 50

The light source lamp support portion 50 is a portion that supports the light source lamp 411 and moves a position in the Y-axis direction of the light source lamp 411 in accordance with the posture of the projector 1 (the normally placed posture or the ceiling-hung posture). As shown in FIG. 2, the light source lamp support portion 50 includes a light-emission-side support portion 5 that supports the light source lamp 411 on a side in the −Z-axis direction of the reflector 412.

In the light-emission-side support portion 5, a support hole 51 is formed. By fitting an end portion of the sealing portion 4111 B extending from the insertion hole 4124 in this support hole 51, the light-emission-side support portion 5 supports the light source lamp 411.

The light-emission-side support portion 5 is arranged to be movable along the Y-axis direction by a distance ΔD due to its self-weight in accordance with the posture of the projector 1. Therefore, when the posture of the projector 1 is changed, the light-emission-side support portion 5 moves in the downward vertical direction by the distance ΔD. Also, the light-emission-side support portion 5 stops at a terminal end in the downward vertical direction of a movable range in each posture of the projector 1.

Accordingly, the light source lamp 411 supported by the light-emission-side support portion 5 also moves in the downward vertical direction by the distance ΔD in accordance with the changing of the posture of the projector 1. When the light-emission-side support portion 5 stops at the terminal end of the movable range, the movement of the light source lamp 411 also stops and the light source lamp 411 is stably supported by the light-emission-side support portion 5 at this stop position.

Note that a detailed description will be given later, but this distance ΔD is set approximately twice as long as the distance ΔL (FIG. 3) from the mechanical center line N (FIG. 3) of the light source lamp 411 to the center position O of the arc C. Also, terminal end positions of the movable range of the light-emission-side support portion 5 are set at the time of assembling of the light source device body 41A.

When the light source device body 41A is assembled, first, the reflector 412 is fixed to the inner wall of the lamp housing 414 (FIG. 1) at the time of the normally placed posture of the projector 1. Then, the light source lamp 411 is arranged in the reflector 412 by inserting the sealing portion 4111B through the insertion hole 4124. Following this, the light-emission-side support portion 5 is set to support the sealing portion 4111B on the side in the −Z-axis direction of the reflector 412.

Next, at the time of the normally placed posture of the projector 1, the light-emission-side support portion 5 is set to arrange the light source lamp 411 so that the center position O of the arc C of the light source lamp 411 is positioned in proximity to a first focal position F1 of a rotation curve shape of the reflection surface 4122A as shown in FIG. 2. Under this condition, the light-emission-side support portion 5 is positioned at the terminal end on the side in the −Y-axis direction of the movable range of the light-emission-side support portion 5.

When the light source lamp 411 is lit up in a state in which the center position O of the arc C is arranged in proximity to the first focal position F1 of the reflector 412 in the manner described above, as shown in FIG. 2, a light beam R directed toward the reflector 412 out of the light beam radiated from the bulge portion 4111A is reflected by the reflection surface 4122A and becomes convergent light that converges at a second focal position F2 of the rotation curve shape of the reflection surface 4122A.

As described above, the light source device body 41A is assembled in a state in which the light-emission-side support portion 5 stops at the terminal end in the −Y-axis direction of the movable range. Therefore, the light-emission-side support portion 5 can move in the +Y-axis direction from this terminal end in the −Y-axis direction by the distance ΔD.

Note that the long diameter in the Y-axis direction of the insertion hole 4124 of the reflector 412 has a size with which the movement of the light-emission-side support portion 5 and the light source lamp 411 within the movable range is not hindered.

When the posture of the projector 1 is changed from the normally placed posture to the ceiling-hung posture, the light-emission-side support portion 5 moves in the downward vertical direction (+Y-axis direction) due to its self-weight and stops at a terminal end in the +Y-axis direction of the movable range. Accordingly, the light source lamp 411 supported by the light-emission-side support portion 5 also moves in the +Y-axis direction, stops at a position at which the mechanical center line N has moved in the +Y-axis direction by ΔD, and is supported at the position.

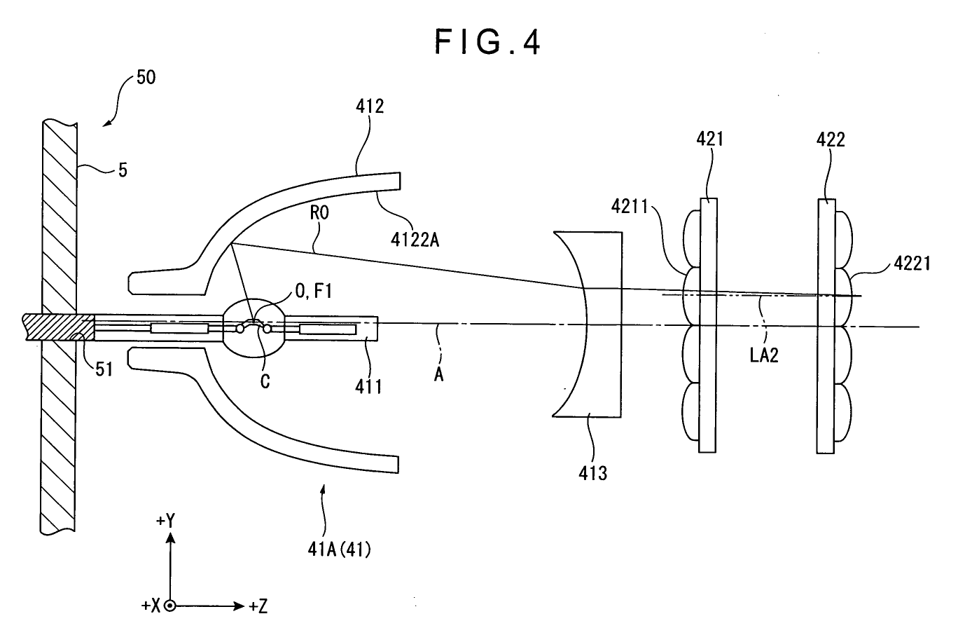

Advantages and effects of the first exemplary embodiment described above will be explained with reference to FIGS. 4 to 6.

In this case, in order to effectively apply the light beam irradiated from the light source device 41 to the liquid crystal panels 451 (FIG. 1) regardless of the posture of the projector 1, it is required that the center position O of the arc C is arranged in proximity to the first focal position F1 of the reflector 412. In this case, an illuminating optical axis A (line connecting the first focal position F1 and the second focal position F2 with each other) of the light beam irradiated from the light source device 41 can coincide with a design optical axis at the integrator illumination optical device 42, so that the light beam irradiated from the light source device 41 can be effectively applied to the liquid crystal panels 451.

FIG. 4 schematically shows a trajectory of the light beam irradiated from the arc C of the light source lamp 411 and directed toward the first lens array 421 and the second lens array 422 at the time of the normally placed posture of the projector 1.

As described above, when the light source device 41 is assembled, the light-emission-side support portion 5 is set to support the light source lamp 411 so that in a state in which the projector 1 is installed in the normally placed posture, the center position O of the arc C is arranged in proximity to the first focal position F1 of the reflector 412. With this arrangement, at the time of the normally placed posture of the projector 1, when the light source lamp 411 is lit up, the center position O of the arc C is arranged in proximity to the first focal position F1 as shown in FIG. 4.

Under this condition, as shown in FIG. 4, a part R0 of the light beam irradiated from the arc C of the light source lamp 411 (light beam forming an arc image on the second lens array 422 through a predetermined first small lens 4211 of the first lens array 421) is reflected by the reflector 412, passes through the parallelizing lens 413, travels along a lens optical axis LA2 of the first small lens 4211 of the first lens array 421, and forms the image on a second small lens 4221 corresponding to the first small lens 4211 of the second lens array 422. That is, in each second small lens 4221, an arc image is formed so that the whole image is contained in the lens.

In the manner described above, at the time of the normally placed posture of the projector 1, the optical axis of the light beam irradiated from the light source device 41 (such as the part R0 of the light beam) is in a state substantially coinciding with the lens optical axis (such as the lens optical axis LA2) of each first small lens 4211 of the first lens array 421 disposed on an optical path downstream side of the light source device 41. As a result, it becomes possible to effectively form an image of each first small lens 4211 of the first lens array 421 on the liquid crystal panels 451 (FIG. 1) with the second lens array 422 and the superposing lens 424 (FIG. 1).

As described above, at the time of the normally placed posture of the projector 1, since the illuminating optical axis A of the light beam irradiated from the light source device 41 can coincide with the design optical axis at the integrator illumination optical device 42, the light beam irradiated from the light source device 41 can be effectively applied to the liquid crystal panels 451, so that the use efficiency of light can be maintained.

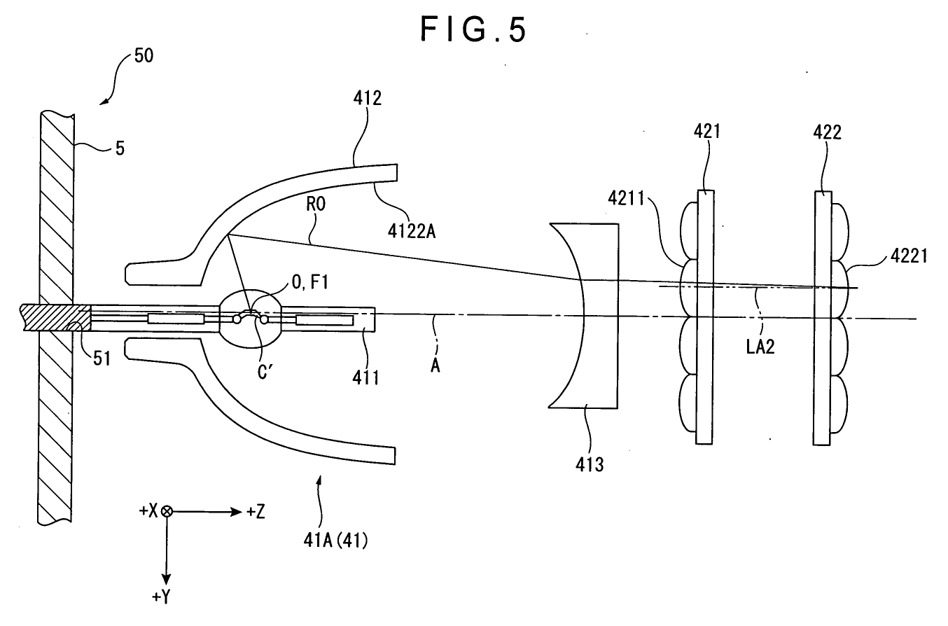

FIG. 5 schematically shows a trajectory of a light beam irradiated from an arc C′ of the light source lamp 411 and directed toward the first lens array 421 and the second lens array 422 at the time of the ceiling-hung posture of the projector 1.

When the projector 1 is installed in the ceiling-hung posture, as shown in FIG. 5, the light-emission-side support portion 5 moves in the downward vertical direction (+Y-axis direction) by the distance ΔD due to its self-weight and stops at the terminal end in the +Y-axis direction of the movable range.

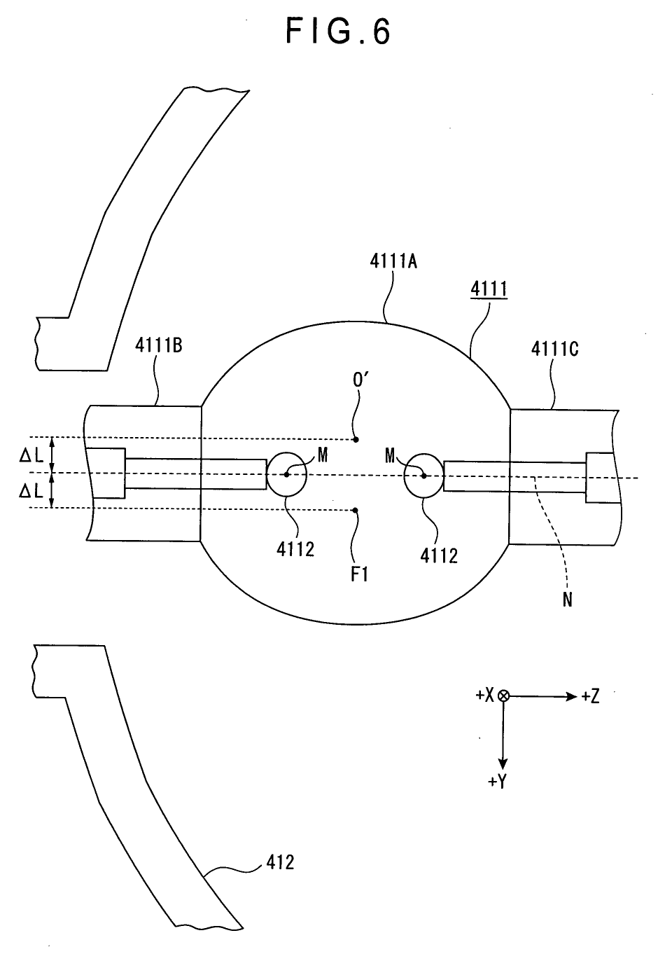

In this case, for ease of explanation, a positional relation between a center position O′ of the arc and the first focal position F1 in the case where the light-emission-side support portion 5 does not move in the downward vertical direction in the projector 1 at the time of the ceiling-hung posture will be described with reference to FIG. 6.

FIG. 6 shows the bulge portion 4111A and the reflector 412 in the case where the light-emission-side support portion 5 does not move in the downward vertical direction in the projector 1 at the time of the ceiling-hung posture.

As shown in FIG. 6, the changing of the posture of the projector 1 to the ceiling-hung posture results in a situation in which the mechanical center line N of the light source lamp 411 passes through a position displaced from the first focal position FI of the reflector 412 in the upward vertical direction (−Y-axis direction) by a distance ΔL.

When the light source lamp 411 is lit up in such positional relation between the light source lamp 411 and the reflector 412, an arc bent in the upward vertical direction (−Y-axis direction) is formed between the electrodes 4112. Therefore, as shown in FIG. 6, the center position O′ of the arc becomes a position displaced from the mechanical center line N in the −Y-axis direction by ΔL. Accordingly, the center position O′ of the arc becomes a position displaced from the first focal position F1 in the −Y-axis direction by 2ΔL.

When the center position O′ of the arc is displaced from the first focal position F1 in the manner described above, the illuminating optical axis of the light beam irradiated from the light source device 41 (FIG. 1) does not coincide with the design optical axis at the integrator illumination optical device 42 (FIG. 1). Accordingly, the light beam irradiated from the light source device 41 is not appropriately applied to the image forming areas of the liquid crystal panels 451 (FIG. 1) and the use efficiency of light at the liquid crystal panels 451 is lowered.

In the first exemplary embodiment, however, when the projector 1 is installed in the ceiling-hung posture, the light-emission-side support portion 5 moves in the downward vertical direction (+Y-axis direction) by the distance ΔD due to its self-weight and stops at the terminal end in the +Y-axis direction of the movable range. Accordingly, the light source lamp 411 supported by the light-emission-side support portion 5 is also supported at a position at which the mechanical center line N has been moved in the +Y-axis direction by the distance ΔD.

As described above, since the distance ΔD is set to be equal to the distance 2ΔL, the mechanical center line N of the light source lamp 411 moves in the +Y-axis direction by the distance 2ΔL. Accordingly, as shown in FIG. 5, the first focal position F1 corresponds to a position displaced from the mechanical center line N in the −Y-axis direction by the distance ΔL.

When the light source lamp 411 is lit up in such positional relation between the light source lamp 411 and the reflector 412, as shown in FIG. 5, the arc C′ is formed between the electrodes 4112 such that it is bent in the upward vertical direction (−Y-axis direction). Also, the center position O′ of the arc C′ is arranged at the position displaced from the mechanical center line N of the light source lamp 411 in the upward vertical direction (−Y-axis direction) by ΔL, which results in a situation in which the center position O′ is positioned in proximity to the first focal position F1.

As described above, when the projector 1 is installed in the ceiling-hung posture, as a result of the movement of the light-emission-side support portion 5 due to its self-weight, the position in the Y-axis direction of the light source lamp 411 with respect to the reflector 412 is moved in the +Y-axis direction by 2ΔL. As a result, it becomes possible to arrange the center position O′ of the arc C′ in proximity to the first focal position F1.

Accordingly, even at the time of the ceiling-hung posture of the projector 1, since the optical axis of the light beam irradiated from the light source device 41 coincides with the design optical axis at the integrator illumination optical device 42, the light beam irradiated from the light source device 41 can be effectively applied to the liquid crystal panels 451.

Also, unlike the structure of the related art in which the whole lamp unit is rotated, the first exemplary embodiment employs an arrangement in which the light source lamp 411 is moved, so that the use efficiency of light of the liquid crystal panels 451 can be maintained with a simple structure that does not increase the size of the projector 1.

In this case, the arcs C and C′ are always bent in the upward vertical direction due to heat convection in the light-emitting tube 4111, which results in a situation in which a displacement generated between the center position O′ of the arc C′ and the first focal position F1 of the reflector 412 when the posture of the projector 1 is changed from the ceiling-hung posture to the normally placed posture is formed in the vertical direction at all times.

In contrast, according to the first exemplary embodiment, since the light source lamp support portion 50 can change the position of the light source lamp 411 in the vertical direction, it becomes possible to sufficiently cope with and correct the displacement between the center position O′ of the arc C′ and the first focal position F1 of the reflector 412 generated due to the changing of the posture of the projector 1. In addition, since the light source lamp support portion 50 is only required to be capable of moving the position of the light source lamp 411 only in the vertical direction, it becomes possible to further suppress an increase in size of the projector 1 and maintain the use efficiency of light of the liquid crystal panels 451 with a simpler structure.

In this case, since the bent shape of each of the arcs C and C′ remains substantially the same regardless of the posture of the projector 1, the distance from the line connecting the center points of the pair of electrodes to each other to the center positions O and O′ of the arcs C and C′ also remains substantially constant regardless of the posture of the projector 1. Accordingly, it becomes possible to grasp the center position O′ of the arc C′ after the changing of the posture of the projector 1.

Therefore, in the first exemplary embodiment, by setting in advance the movement amount ΔD of the light source lamp 411 by the light-emission-side support portion 5 according to the changing of the posture of the projector 1, it becomes possible to swiftly eliminate the displacement between the center position O′ of the arc C′ and the first focal position F1 at the time of the changing of the posture of the projector 1.

As a result, it is unnecessary for a user of the projector 1 to adjust the position of the light source lamp 411 with the light source lamp 411 support portion while monitoring the positional relation between the center position O′ of the arc C′ and the first focal position F1 at the time of the changing of the posture of the projector 1. Accordingly, it becomes possible to maintain the use efficiency of light of the liquid crystal panels 451 without necessity of bothersome operations of the user.

In the first exemplary embodiment, since the light-emission-side support portion 5 is set to support the light source lamp 411 on the side in the −Z-axis direction (side opposite to the light-irradiation side) of the reflector 412, the light beam irradiated from the reflector 412 is not blocked. Accordingly, the light-emission-side support portion 5 can support the light source lamp 411 without lowering the use efficiency of light at the liquid crystal panels 451.

### Second Exemplary Embodiment

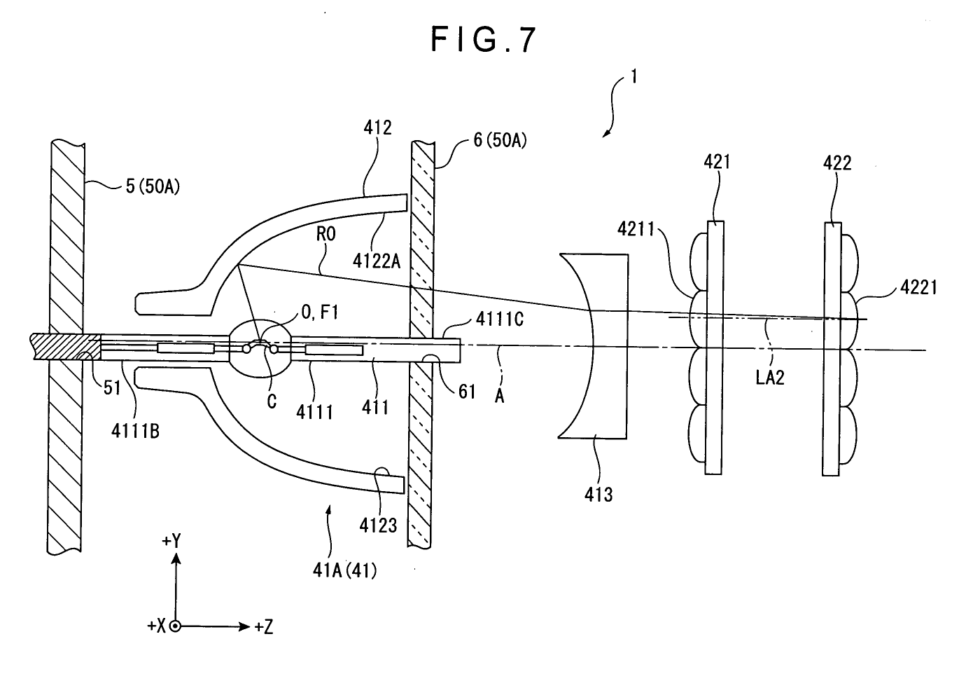

A second exemplary embodiment according to the invention will be described with reference to FIG. 7.

In the projector 1 according to the first exemplary embodiment described above, the light source lamp support portion 50 (FIG. 2) supports the light source lamp 411 only on a side opposite to the light-irradiation side of the reflector 412. The projector 1 of the second exemplary embodiment is different from that of the first exemplary embodiment in that a light source lamp support portion 50A supports the light source lamp 411 also on the light-irradiation side of the reflector 412. Note that in the following description, the structures and members similar to those of the first exemplary embodiment are given the same reference symbols and detailed description thereof will be omitted or simplified.

FIG. 7 is a Y-Z cross-sectional view showing outlined arrangements of the light source device body 41A and the light source lamp support portion 50A in the projector 1 at the time of the normally placed posture according to the second exemplary embodiment. Note that in FIG. 7, as in FIGS. 2 to 6, the optical axis of the light beam irradiated from the light source device 41 is set as the Z axis and two axes orthogonal to this Z axis are respectively set as the X axis (horizontal axis) and the Y axis (vertical axis). Also, the irradiation direction of the light beam from the light source device 41 is set as the +Z-axis direction. Further, the upward vertical direction at the time of the normally placed posture of the projector 1 is set as the +Y-axis direction and the downward vertical direction is set as the −Y-axis direction. That is, the upward vertical direction at the time of the ceiling-hung posture of the projector 1 is set as the −Y-axis direction and the downward vertical direction is set as the +Y-axis direction.

The projector 1 of the second exemplary embodiment differs from the projector 1 of the first exemplary embodiment in the arrangement of the sealing portion 4111C of the light-emitting tube 4111 and the arrangement of the light source lamp support portion 50A. Specifically, a size in the +Z-axis direction of the sealing portion 4111C of the light-emitting tube 4111 is set to be longer than that of the first exemplary embodiment and an end portion in the +Z-axis direction of the sealing portion 4111C protrudes from the opening 4123 of the reflector 412 in the +Z-axis direction.

Also, as shown in FIG. 7, the light source lamp support portion 50A of the second exemplary embodiment includes the light-emission-side support portion 5 and an irradiation-side light-transmissive support portion 6.

The irradiation-side light-transmissive support portion 6 supports the end portion of the sealing portion 4111C exposed from the opening 4123 and moves the position in the Y-axis direction of the light source lamp 411 in accordance with the posture of the projector 1 in cooperation with the light-emission-side support portion 5.

The irradiation-side light-transmissive support portion 6 is formed of a light-transmissive glass material in a flat-plate shape. The irradiation-side light-transmissive support portion 6 is arranged so as to extend substantially parallel to an X-Y plane and completely contains an effective optical path diameter of light that reaches the first lens array 421 on a side in the +Z-axis direction of the reflector 412 out of the light beam irradiated from the reflector 412.

A support hole 61 is formed substantially at the center of the irradiation-side light-transmissive support portion 6. Through insertion and fitting of the end portion in the +Z-axis direction of the sealing portion 4111C into this support hole 61, the irradiation-side light-transmissive support portion 6 supports the light source lamp 411 together with the light-emission-side support portion 5.

The irradiation-side light-transmissive support portion 6 is arranged to be movable along the Y-axis direction by the distance ΔD due to its self-weight as in the case of the arrangement of the light-emission-side support portion 5. In addition, both terminal ends in the Y-axis direction of a movable range of the irradiation-side light-transmissive support portion 6 coincide with both terminal ends in the Y-axis direction of the movable range of the light-emission-side support portion 5.

With the arrangement, when the projector 1 is installed in the ceiling-hung posture, both the light-emission-side support portion 5 and the irradiation-side light-transmissive support portion 6 move in the downward vertical direction (+Y-axis direction) by the distance ΔD and stop at the terminal ends in the +Y-axis direction of the movable ranges. Accordingly, the light source lamp 411 supported by the light-emission-side support portion 5 and the irradiation-side light-transmissive support portion 6 also move in the +Y-axis direction by the distance ΔD.

According to the second exemplary embodiment, the same advantages and effects as in the first exemplary embodiment can be provided.

Specifically, when the projector 1 is installed in the ceiling-hung posture, the position in the Y-axis direction of the light source lamp 411 moves in the +Y-axis direction by 2ΔL (FIGS. 3 and 6) in accordance with the movement of the light-emission-side support portion 5 and the irradiation-side light-transmissive support portion 6. As a result, the center position of the arc is arranged in proximity to the first focal position F1. Accordingly, even at the time of the ceiling-hung posture of the projector 1, since the illuminating optical axis A of the light beam irradiated from the light source device 41 coincides with the design optical axis at the integrator illumination optical device 42, the light beam irradiated from the light source device 41 can be effectively applied to the liquid crystal panels 451.

Also, in the second exemplary embodiment, since the light-emission-side support portion 5 supports the sealing portion 4111B of the light-emitting tube 4111, and the irradiation-side light-transmissive support portion 6 supports the sealing portion 4111C, the light-emitting tube 4111 can be stably supported. Further, the light source lamp 411 can be stably moved, so that it is possible to suppress an error of a movement distance of the light source lamp 411.

Further, since the irradiation-side light-transmissive support portion 6 has a light-transmissive property and is provided to completely contain the effective optical path diameter of the light that reaches the first lens array 421 out of the light beam irradiated from the reflector 412, the irradiation-side light-transmissive support portion 6 does not block the light beam irradiated from the reflector 412. Accordingly, the light source lamp support portion 50A can stably support the light source lamp 411 without lowering the light use efficiency of the light beam irradiated from the light source device 41.

### Third Exemplary Embodiment

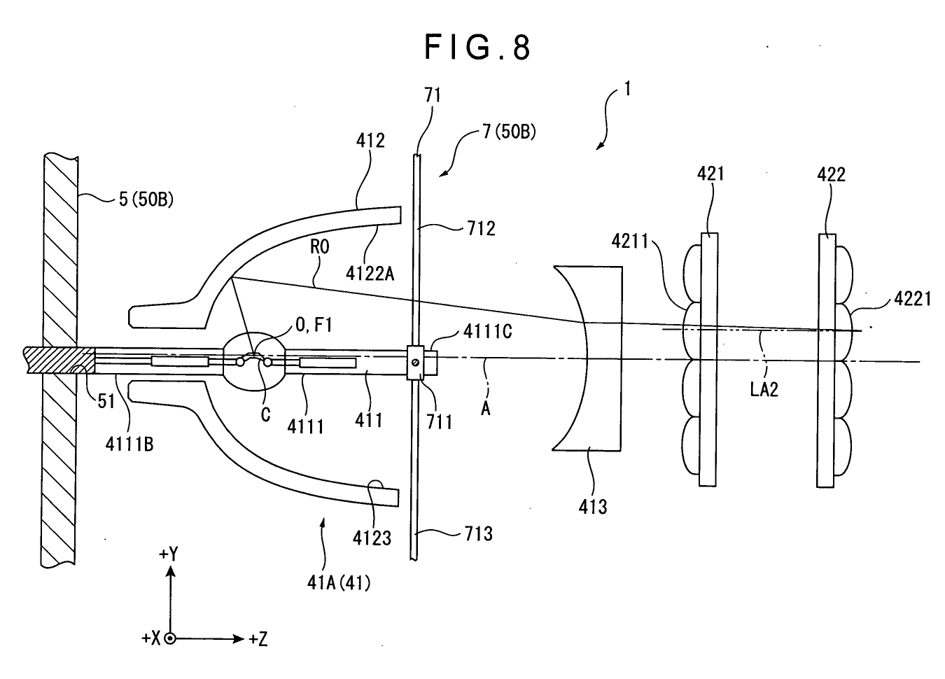

A third exemplary embodiment of the invention will be described with reference to FIG. 8.

The projector 1 of the third exemplary embodiment differs from that of the second exemplary embodiment described above in that a light source lamp support portion 50B is provided in place of the light source lamp support portion 50A (FIG. 7).

In the following description, the structures and members similar to those of the first and the second exemplary embodiments described above are given the same reference numerals and detailed description thereof will be omitted or simplified.

FIG. 8 is a Y-Z cross-sectional view showing outlined arrangements of the light source device body 41A and the light source lamp support portion 50B in the projector 1 at the time of the normally placed posture according to the third exemplary embodiment. Note that in FIG. 8, as in FIGS. 2 to 7, the optical axis of the light beam irradiated from the light source device 41 is set as a Z axis and two axes orthogonal to this Z axis are respectively set as a X axis (horizontal axis) and the Y axis (vertical axis). Also, the irradiation direction of the light beam from the light source device 41 is set as a +Z-axis direction. Further, the upward vertical direction at the time of the normally placed posture of the projector 1 is set as a +Y-axis direction and the downward vertical direction is set as a −Y-axis direction. That is, the upward vertical direction at the time of the ceiling-hung posture of the projector 1 is set as a −Y-axis direction and the downward vertical direction is set as a +Y-axis direction.

The projector 1 of the third exemplary embodiment differs from that of the second exemplary embodiment in the arrangement of the light source lamp support portion 50B. As shown in FIG. 8, the projector 1 of the third exemplary embodiment includes the light source lamp support portion 50B that supports the light source lamp 411 and is capable of changing the position in the Y-axis direction of the light source lamp 411. The light source lamp support portion 50B includes the light-emission-side support portion 5 and an irradiation-side support portion 7.

The irradiation-side support portion 7, as shown in FIG. 8, supports the end portion of the sealing portion 4111C exposed from the opening 4123 of the reflector 412 and moves the position in the Y-axis direction of the light source lamp 411 in accordance with the posture of the projector 1 together with the light-emission-side support portion 5.

The irradiation-side support portion 7 includes a support arm portion 71 that supports the end portion of the sealing portion 4111C. The support arm portion 71 is made of a heat-resistant material and includes a circular tube portion 711 having a cylindrical shape into which the end portion of the sealing portion 4111C is fitted in an inserted state, a wire portion 712 that extends from the circular tube portion 711 in the +Y-axis direction and a wire portion 713 that extends from the circular tube portion 711 in the −Y-axis direction. Dispositions of the circular tube portion 711 and the wire portions 712 and 713 with respect to the light source device body 41A will be described later.

Similar to the light-emission-side support portion 5, the irradiation-side support portion 7 is arranged to be movable along the Y-axis direction by the distance ΔD due to its self-weight. In addition, both terminal ends in the Y-axis direction of a movable range of the irradiation-side support portion 7 coincide with both terminal ends in the Y-axis direction of the movable range of the light-emission-side support portion 5.

With the arrangement, when the projector 1 is installed in the ceiling-hung posture, both the light-emission-side support portion 5 and the irradiation-side support portion 7 move in the downward vertical direction (+Y-axis direction) by the distance ΔD and stop at the terminal ends in the +Y-axis direction of the movable ranges. Accordingly, the light source lamp 411 supported by the light-emission-side support portion 5 and the irradiation-side support portion 7 also move in the +Y-axis direction by the distance ΔD.

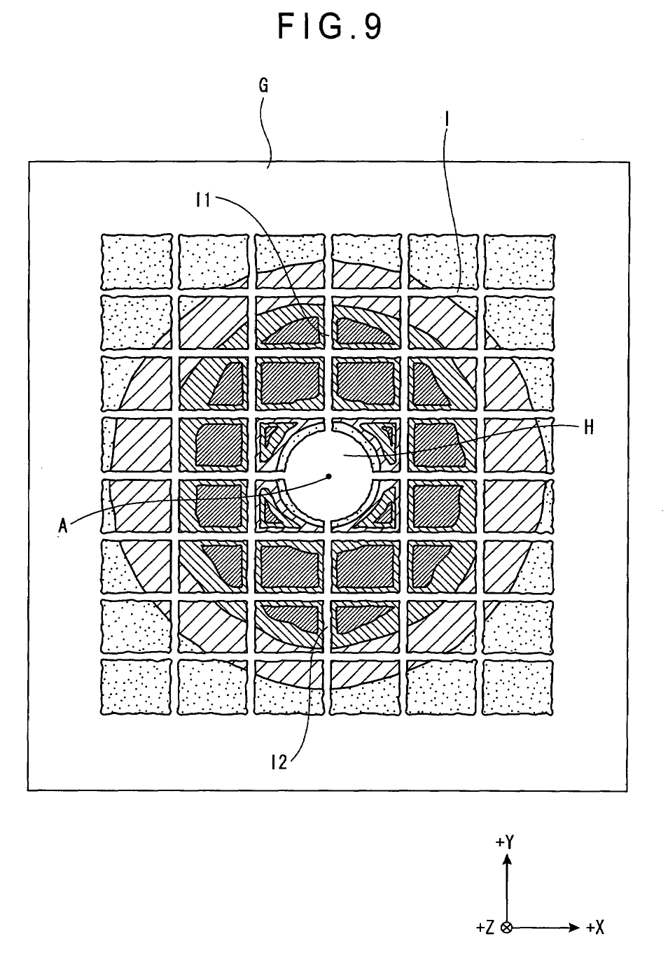

FIG. 9 shows light quantity distribution of light that reaches the image forming areas of the liquid crystal panels 451 (FIG. 1) out of a light beam transmitted through a transmission plane G set to be orthogonal to the illuminating optical axis A between the reflector 412 and the first lens array 421.

Note that also in FIG. 9, as in FIG. 8, the optical axis of the light beam irradiated from the light source device 41 is set as a Z axis and two axes orthogonal to this Z axis are respectively set as a X axis (horizontal axis) and the Y axis (vertical axis). Also, a direction in which the light beam is incident on the first lens array 421, is set as a +Z-axis direction. Further, the upward vertical direction at the time of the normally placed posture of the projector 1 is set as a +Y-axis direction and the downward vertical direction is set as a −Y-axis direction. That is, the upward vertical direction at the time of the ceiling-hung posture of the projector 1 is set as a −Y-axis direction and the downward vertical direction is set as a +Y-axis direction.

Also, in FIG. 9, the transmission plane G is illustrated such that an area with the minimum light quantity is shown in white and areas with more light quantities are shown by reducing intervals between hatched lines (oblique lines) in the areas.

As shown in FIG. 9, out of the light beam irradiated from the reflector 412, light transmitted through an area H of the transmission plane G in the vicinity of the illuminating optical axis A and light transmitted through an area I of the transmission plane G formed in a lattice pattern are not used so much in the image forming areas of the liquid crystal panels 451.

This is because a shadow of the light-emitting tube 4111 appears and the quantity of light in the vicinity of the illuminating optical axis A of the light beam irradiated from the reflector 412 is reduced, and therefore the quantity of light transmitted through the area H is also reduced.

Also, the light transmitted through the area I is incident on each boundary portion between the first small lenses 4211 arranged in a matrix form in a plane of the first lens array 421. However, the light incident on the boundary portion between the first small lenses 4211 is not appropriately refracted at each of the first small lens 4211 and is hard to reach the liquid crystal panels 451, so that almost all of the light incident on the boundary portion is not used in image formation at the image forming areas.

The circular tube portion 711 and the two wire portions 712 and 713 (FIG. 8) are arranged so as to be contained in the optical paths of the light irradiated from the reflector 412 and incident on the areas H and I (FIG. 9) of the transmission plane G at the time of the normally placed posture of the projector 1.

Specifically, the circular tube portion 711 is provided along an exterior surface of the sealing portion 4111C, so the circular tube portion 711 is contained in the optical path of the light incident on the area H.

Also, the wire portion 712 is extended so as to be contained in an optical path of light incident on an area I1 of the area I which extends from the area H in the +Y-axis direction. Further, the wire portion 713 is extended so as to be contained in an optical path of light incident on an area 12 of the area I which extends from the area H in the −Y-axis direction.

According to the third exemplary embodiment, the same advantages and effects as in the case of the projectors 1 of the first and second exemplary embodiments can be provided.

Specifically, when the projector 1 is installed in the ceiling-hung posture, the position in the Y-axis direction of the light source lamp 411 moves in the +Y-axis direction by 2ΔL (FIG. 6) in accordance with the movement of the light-emission-side support portion 5 and the irradiation-side support portion 7 due to their self-weights. As a result, the center position of the arc is arranged in proximity to the first focal position F1. Accordingly, even at the time of the ceiling-hung posture of the projector 1, the illuminating optical axis A of the light beam irradiated from the light source device 41 coincides with the design optical axis at the integrator illumination optical device 42, so that the light beam irradiated from the light source device 41 can be effectively applied to the liquid crystal panels 451.

Also, in the third exemplary embodiment, since the light-emission-side support portion 5 supports the sealing portion 411 1B of the light-emitting tube 4111 and the irradiation-side support portion 7 supports the sealing portion 4111C, the light-emitting tube 4111 can be stably supported. Further, since the light source lamp 411 can be stably moved, it is possible to suppress an error of a movement distance of the light source lamp 411.

In the third exemplary embodiment, the wire portions 712 and 713 of the support arm portion 71 are provided so as to be contained in the optical path of the light that is incident on each boundary portion between the first small lenses 4211 of the first lens array 421 out of the light beam irradiated from the reflector 412. Therefore, the support arm portion 71 blocks the light incident on the boundary portion between the first small lenses 4211, but the light incident on the boundary portion between the first small lenses 4211 is light that is hard to reach the image forming areas of the liquid crystal panels 451, so that an influence on a projection image is extremely small. Accordingly, the support arm portion 71 is provided so as not to block light that is easy to reach the image forming areas of the liquid crystal panels 451, and therefore the light source lamp 411 can be supported in a state in which the use efficiency at the liquid crystal panels 451 is maintained.

### Modifications of Exemplary Embodiments

The best arrangement and the like for carrying out the invention are disclosed in the above description, but the invention is not limited thereto. In other words, each exemplary embodiment described above does not limit the invention, and modifications in which a part or all of the limitations such as shapes and materials of the components of the exemplary embodiments are removed, are included in the invention.

In each exemplary embodiment described above, an arrangement is explained in which the light source lamp 411 is supported by the light source lamp support portion 50, 50A, 50B on the side in the −Y-axis direction of the reflector 412 or on both of the side in the +Y-axis direction and the side in the −Y-axis direction of the reflector 412, but in the invention, an arrangement in which the light source lamp support portion supports the light source lamp 411 only on the side in the +Y-axis direction of the reflector 412 may be employed.

In the third exemplary embodiment, the wire portions 712 and 713 are extended so as to be contained in the optical paths of the light beams transmitted through the areas I1 and I2 of the transmission plane G. In the invention, however, the wire portions 712 and 713 may be extended so as to be contained in the area I of the transmission plane G so long as the wire portions 712 and 713 can stably support the light source lamp 411. Also, for instance, the sealing portion 4111C may be supported only with the wire portion 712. Further, for instance, the wire portions may be formed in a step shape extending along the area I.

In each exemplary embodiment, the light source device body 41A includes the light source lamp 411 and the reflector 412, but the invention is not limited thereto, and a sub-reflection mirror that covers approximately one half of the bulge portion 4111A of the light source lamp 411 on the light-irradiation side and reflects an incident light beam toward the reflector 412 may be provided in the light source device body 41A.

In the second exemplary embodiment, a light-transmissive glass member is used as the irradiation-side light-transmissive support portion 6. However, in the invention, when an explosion-proof glass member that, when the light source lamp 411 bursts, prevents broken pieces of the light source lamp 411 from scattering to the outside from the light source device body 41A is provided for the light source device body 41A, it is possible to use the explosion-proof glass member as the light source lamp support portion. In this case, an increase of the number of components due to addition of new components can be prevented.

In each exemplary embodiment described above, an arrangement is explained in which the optical unit 4 has a substantially L-shape in plan view, but the invention is not limited thereto. For instance, the optical unit 4 having a substantially U-shape in plan view may be employed.

Also, in each exemplary embodiment described above, light-transmissive liquid crystal panel 451 having different light-incident surface and light-irradiation surface are used, but reflection-type liquid crystal panel having a common light-incident surface and light-irradiation surface may be used.

Further, in the projector 1 according to each exemplary embodiment described above, three liquid crystal panels 451R, 451G, and 451B are used, but the invention is not limited thereto. Specifically, the invention is also applicable to a projector that uses two liquid crystal panels or four or more liquid crystal panels.

In each exemplary embodiment described above, the projector 1 that includes the liquid crystal panels 451 as optical modulators is described as an example, but optical modulators having another arrangement may be employed so long as the optical modulators form optical images by modulating incident light beams in accordance with image information. For instance, the invention is also applicable to a projector that uses optical modulators not using liquid crystal layers such as devices using micromirrors. When such optical modulators are used, the polarization plates 452 and 453 on the light-incident side and the light-irradiation side can be omitted.

In each exemplary embodiment described above, only the front-type projector 1 that performs image projection from a direction in which a screen is observed is explained as an example, but the invention is also applicable to a rear-type projector that performs image projection in a direction opposite to the screen observation direction.

The projector according to the invention is capable of maintaining the use efficiency of light by supporting both in the normally placed posture and the ceiling-hung posture with a simple structure which does not increase the size of the light source device, and therefore is useful as a projector that is used for presentation or a home theater.

What is claimed is:

1. A projector, comprising:
a light source device, the light source device including a light source lamp and a reflector, the light source lamp having a pair of electrodes and a light-emitting tube in which the pair of electrodes are arranged, the reflector irradiating the light beam radiated from the light source lamp in a certain direction;
an optical modulator that modulates a light beam irradiated from the light source device;
a projection optical device that projects the light beam modulated by the optical modulator in an enlarged manner;
an exterior casing that houses the light source device, the optical modulator, and the projection optical device to be arranged therein, the reflector fixed to the exterior casing; and
a light source lamp support portion that supports the light source lamp, the light source lamp support portion being adapted to change a position of the light source lamp with respect to the reflector in accordance with a posture of the projector, the posture including a normally placed posture in which the projector is placed at a predetermined position and a ceiling-hung posture in which the projector is arranged inversely from the normally placed posture in a vertical direction.

2. The projector according to claim 1, wherein
the light source lamp support portion is adapted to change the position of the light source lamp with respect to the reflector in the vertical direction.

3. The projector according to claim 1, wherein
an arc is formed between the pair of electrodes of the light source lamp due to discharge light emission when a voltage is applied, and
the light source lamp support portion changes the position of the light source lamp such that a center position of the arc with respect to the reflector in the normally placed posture of the projector and a center position of the arc with respect to the reflector in the ceiling-hung posture of the projector coincide with each other.

4. The projector according to claim 1, wherein
the reflector has a substantially bowl-like shape in which the light-emitting tube is arranged, the reflector including: an opening that exposes one end portion of the light-emitting tube, the opening formed on an irradiation side of the light beam irradiated by the reflector in the certain direction; and an insertion hole through which the other end portion of the light-emitting tube is inserted, the insertion hole formed on a side opposite to the light-irradiation side, and
the light source lamp support portion supports at least one of the end portion of the light-emitting tube exposed from the opening and the other end portion of the light-emitting tube inserted through the insertion hole and extending to an outside of the reflector.

5. The projector according to claim 4, wherein
the light source lamp support portion includes an irradiation-side light-transmissive support portion, and
the irradiation-side light-transmissive support portion has a light-transmissive property, supports the end portion of the light-emitting tube exposed from the opening of the reflector, and is adapted to change the position of the light source lamp with respect to the reflector.

6. The projector according to claim 4, further comprising:
an integrator illumination optical device that is disposed on an optical path downstream side of the light beam irradiated from the light source device, the integrator illumination optical device substantially uniformly illuminating an image forming area of the optical modulator with the light beam, wherein
the integrator illumination optical device includes:
a first lens array that includes a plurality of first small lenses arranged in a plane substantially orthogonal to an optical axis of an incident light beam, the first lens array dividing the incident light beam into a plurality of sub light beams with the plurality of first small lenses;
a second lens array that includes a plurality of second small lenses according to the plurality of first small lenses of the first lens array; and
a superposing lens that superposes the incident light beam on the image forming area of the optical modulator together with the second lens array,
the light source lamp support portion includes an irradiation-side support portion,
the irradiation-side support portion includes a support arm portion that supports the end portion of the light-emitting tube exposed from the opening of the reflector, the irradiation-side support portion adapted to change the position of the light source lamp with respect to the reflector, and
the support arm portion is arranged in optical paths of, out of the light beam irradiated from the light source device, light in the vicinity of an optical axis of the light beam and light incident on each boundary portion between the plurality of first small lenses of the first lens array.
